(19) United States
(12) Patent Application Publication
(10) Pub. No.: US 2006/0119198 A1
(43) Pub. Date: Jun. 8, 2006

(54) Shaftless magnetic trajectory fan

(76) Inventor: Chuy-Nan Chio, Taipei (TW)

Correspondence Address: DENNISON, SCHULTZ, DOUGHERTY & MACDONALD, 1727 KING STREET, SUITE 105, ALEXANDRIA, VA, 22314, US

(21) Appl. No.: 11/002,108

(22) Filed: Dec. 3, 2004

(51) Int. Cl. H02K 7/09; F04B 35/04; F04B 17/00

(52) U.S. Cl. 310/90.5; 417/410.1; 417/423.1; 417/424.1

(57) ABSTRACT

A shaftless magnetic trajectory fan principally includes a magnetic track, a controller and a magnetic fan. The magnetic track comprises two outwardly-opened U-shaped magnetic conducting rings coupled with each other, wherein each of the two U-shaped magnetic conducting rings has therein a ring-shaped magnet with different poles at the inner and outer edges, and the connection portion of the two U-shaped magnetic conducting rings has thereon another ring-shaped magnet with different poles at the inner and outer edges. The controller has thereon several electromagnets formed of coils. In addition, the magnetic fan includes a top cover with several blades on the outer edge and a magnetic-levitated main body, wherein the magnetic-levitated main body has therein a ring-shaped magnet, the magnetic-levitated main body is upwardly coupled with a ring-shaped magnet corresponding to the electromagnets of the controller, and the top cover covers the outer edge of the magnetic-levitated main body. The ring-shaped magnet provided in the magnetic-levitated main body is accommodated between the two ring-shaped magnets of the magnetic track, the ring-shaped magnet provided in the magnetic-levitated main body is suspended in the outer edge of the magnetic track according to the principle “like magnetic poles repel each other”, and the ring-shaped magnet with which the magnetic-levitated main body is upwardly coupled drives rotation of the magnetic fan when a circuit flows through the electromagnets of the controller.

### BACKGROUND OF THE INVENTION

1. Field of the Invention

The invention relates to a shaftless magnetic trajectory fan, and in particular, to a shaftless magnetic trajectory fan with no noise, no friction, no heat generation and extended life.

2. Description of the Prior Art

The conventional fan is usually designed by using a bearing or oil seal to fix the central shaft thereof. Since the central shaft may rub against the bearing or oil seal upon rotation of the fan, the use of the bearing or oil seal will generate noise. In addition, after the central shaft is abraded by the bearing or oil seal, some crumbs resulted from the central shaft may be dispersed on an article requiring heat dissipation. This abrasion may also generate heat, and thus lead to dynamic energy loss of the rotating fan. Furthermore, in the case that the oil seal is employed to fix the central shaft, the gaseous oil may directly blow onto the article requiring heat dissipation.

In order to solve the above problems, a so-called magnetic fan shown in FIGS. 4 and 5 is developed. This magnetic fan 3 is operated according to the principle “like magnetic poles repel each other”, such that the central shaft 33 is suspended in the air and the problems occurred in the conventional fans are thus overcome. However, the commercialized magnetic fan 3 still has some advantages. For example, in the magnetic fan 3 shown in FIG. 4, the outer edge of the central shaft 33 is covered with a magnet 34. In addition, a magnet 22 is provided on the inner periphery of a controller 2 of the magnetic fan 3 corresponding to the location of the magnet 34 covering the central shaft 33. According to the principle “like magnetic poles repel each other”, the object of magnetic levitation can be achieved. However, the magnet 22 disposed on the inner periphery of the controller 2 is readily interacted with the electromagnet 21 disposed on the outer edge of the controller 2 for driving rotation of the magnetic fan 3. Therefore, the magnetic filed is varied or a demagnetization phenomenon is generated, and the service life of the magnetic fan is reduced. In addition, a retaining hole 23 is provided on the bottom of the controller 2 of the magnetic fan 3 for penetrating therein the central shaft 33 in order to position the central shaft 33. However, upon rotation of the magnetic fan 3, the central shaft 33 also rubs against the inner periphery of the retaining hole 23, i.e. the conventional problems of having noise, crumbs, heat energy, etc. are occurred.

Referring to FIG. 5, another conventional magnetic fan 3 is illustrated. The magnetic fan 3 has a base 36 disposed at the bottom thereof for sustaining thereon a central shaft 33 of the magnetic fan 3. In addition, several iron plates 35 are provided on the lateral sides of the base 36 such that the magnet 34 disposed on the inner periphery of the magnetic fan 3 and the iron plates 35 with attract each other. In this manner, the magnetic fan 3 is pressed downward so as to prevent from drifting up and down when the magnetic fan 3 is rotated. This type of magnetic fan 3, however, has similar drawback as that described in the above paragraph. Since the central shaft 3 of the magnetic fan 3 is sustained against the base 36, the conventional problems of having noise, crumbs, heat energy, etc. are occurred.

Accordingly, the conventional art mentioned above has still many disadvantages and is not designed perfectly such that it needs to be improved immediately.

In view of the various disadvantages associated with the prior art product, the inventor of this application had devoted to improve it and, after studying intensively for many years, accomplished successfully the present shaftless magnetic trajectory fan.

### SUMMARY OF THE INVENTION

It is an object of the present invention to provide a shaftless magnetic trajectory fan without generating noise.

It is another object of the present invention to provide a shaftless magnetic trajectory fan having an extended service life.

It is a further object of the present invention to provide a shaftless magnetic trajectory fan having no dynamic energy loss due to the heat generated from abrasion.

It is a still object of the present invention to provide a shaftless magnetic trajectory fan having low impedance but high rotating speed.

The shaftless magnetic trajectory fan that can accomplish the above-described objects according to the invention includes a magnetic track, a controller and a magnetic fan. The magnetic track comprises two outwardly-opened U-shaped magnetic conducting rings coupled with each other, wherein each of the two U-shaped magnetic conducting rings has therein a ring-shaped magnet with different poles at the inner and outer edges, and the connection portion of the two U-shaped magnetic conducting rings has thereon another ring-shaped magnet with different poles at the inner and outer edges. The controller has thereon several electromagnets formed of coils. The magnetic fan includes a top cover with several blades on the outer edge and a magnetic-levitated main body, wherein the magnetic-levitated main body has therein a ring-shaped magnet with different poles at the inner and outer edges, the pole at the inner edge of the ring-shaped magnet of the magnetic-levitated main body is the same as that at the outer edge of the ring-shaped magnet of the magnetic track, the magnetic-levitated main body is upwardly coupled with a ring-shaped magnet corresponding to the electromagnets of the controller, and the top cover covers the outer edge of the magnetic-levitated main body.

### BRIEF DESCRIPTION OF THE DRAWINGS

The drawings disclose an illustrative embodiment of the present invention which serves to exemplify the various advantages and objects hereof, and are as follows:

FIG. 1 is an exploded perspective view of a shaftless magnetic trajectory fan according to the present invention;

FIG. 2 is a side cross-sectional view of the shaftless magnetic trajectory fan according to the present invention;

FIG. 3 is a diagram illustrating pole distribution of the shaftless magnetic trajectory fan according to the present invention;

FIG. 3A is a diagram illustrating another pole distribution of the shaftless magnetic trajectory fan according to the present invention;

FIG. 4 is a schematic side cross-sectional view of a conventional magnetic fan; and

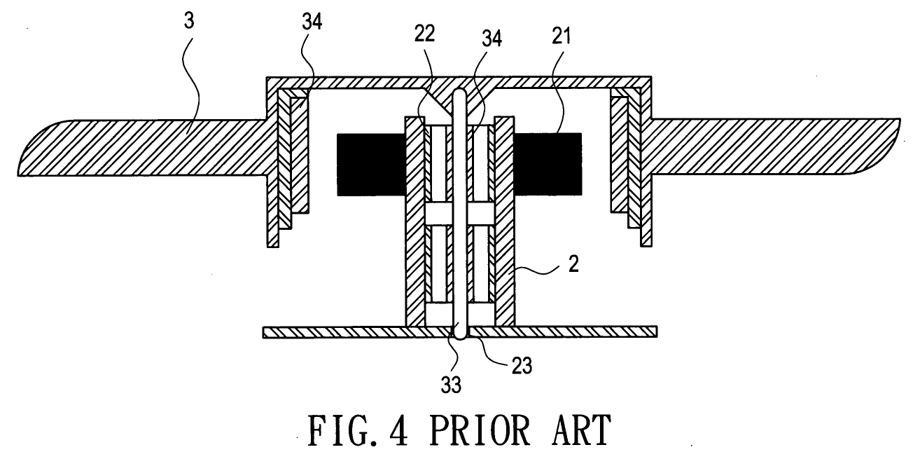

FIG. 5 is a schematic side cross-sectional view of another conventional magnetic fan.

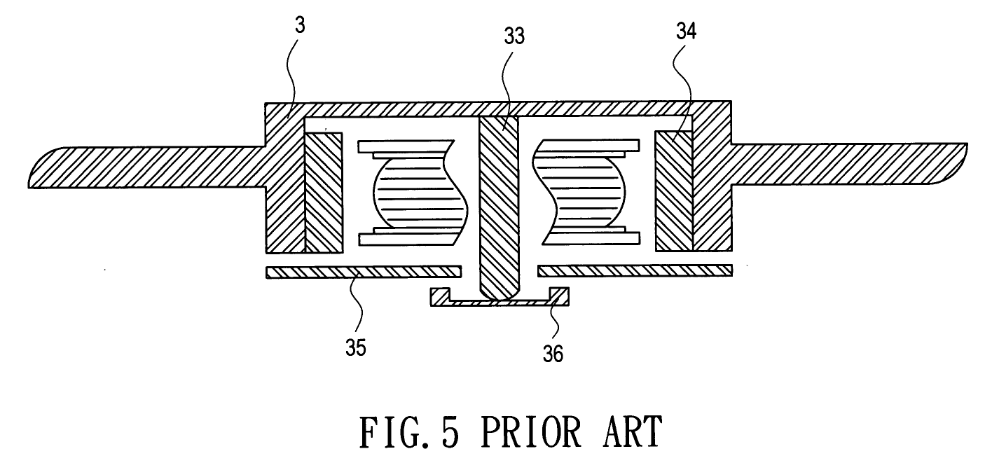

### DETAILED DESCRIPTION OF THE PREFERRED EMBODIMENT

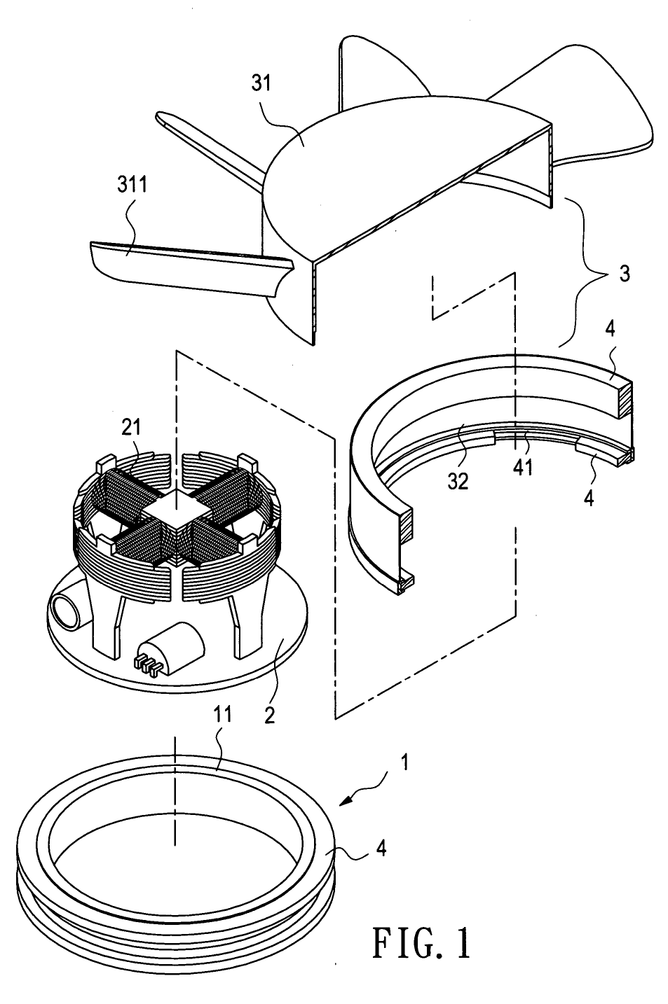

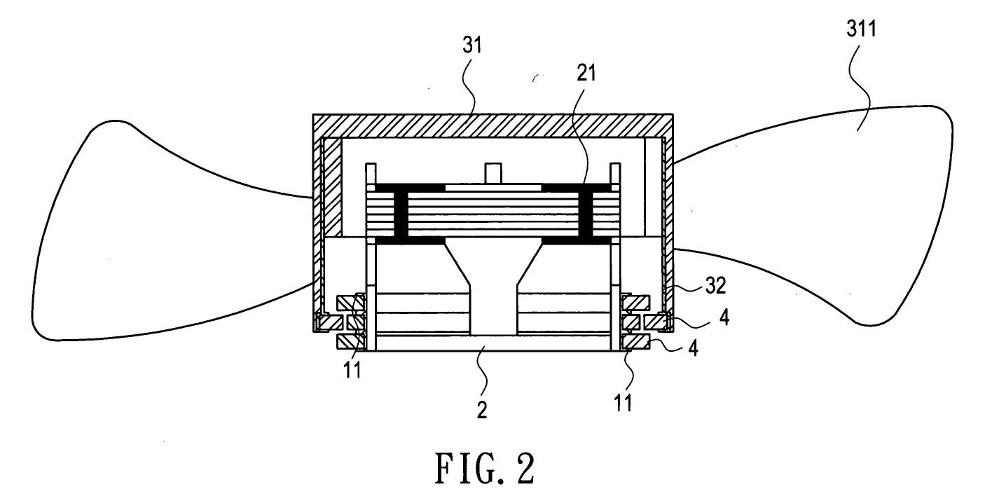

Referring to FIGS. 1 and 2, a shaftless magnetic trajectory fan provide by the present invention is illustrated. The shaftless magnetic trajectory fan principally comprises a magnetic track 1, a controller 2 and a magnetic fan 3.

The magnetic track 1 comprises two outwardly-opened U-shaped magnetic conducting rings 11 coupled with each other, wherein each of the two U-shaped magnetic conducting rings 11 has therein a ring-shaped magnet 4 with different poles at the inner and outer edges, and the connection portion of the two U-shaped magnetic conducting rings 11 has thereon another ring-shaped magnet 4 with different poles at the inner and outer edges.

The controller 2 has thereon several electromagnets 21 formed of coils.

The magnetic fan 3 comprises a top cover 31 with several blades 311 on the outer edge and a magnetic-levitated main body 32, wherein the magnetic-levitated main body 32 has therein a ring-shaped magnet 4 with different poles at the inner and outer edges, the pole at the inner edge of the ring-shaped magnet 4 of the magnetic-levitated main body 32 is the same as that at the outer edge of the ring-shaped magnet 4 of the magnetic track 1, in addition, the inner edge of the ring-shaped magnet 4 provided in the magnetic-levitated main body 32 has several openings 41, the magnetic-levitated main body 32 is upwardly coupled with a ring-shaped magnet 4 corresponding to the electromagnets 21 of the controller 2, and the top cover 31 covers the outer edge of the magnetic-levitated main body 32.

Each of the two U-shaped magnetic conducting rings 11 and the magnetic-levitated main body 32 is made of a magnetic conducting material. The ring-shaped magnet 4 provided in the magnetic-levitated main body 32 is accommodated between the two ring-shaped magnets 4 of the magnetic track 1 via the openings 41 thereon such that the ring-shaped magnet 4 provided in the magnetic-levitated main body 32 faces to the ring-shaped magnet 4 at the connection portion of the two U-shaped magnetic conducting rings 11. The ring-shaped magnet 4 provided in the magnetic-levitated main body 32 is suspended between the two ring-shaped magnets 4 of the magnetic track 1 according to the principle “like magnetic poles repel each other” and suspended in the outer edge of the magnetic track 1 when interacted by the ring-shaped magnet 4 at the connection portion of the two U-shaped magnetic conducting rings 11. The ring-shaped magnet 4 with which the magnetic-levitated main body 32 is upwardly coupled drives rotation of the magnetic fan 3 when a circuit flows through the electromagnets 21 of the controller 2.

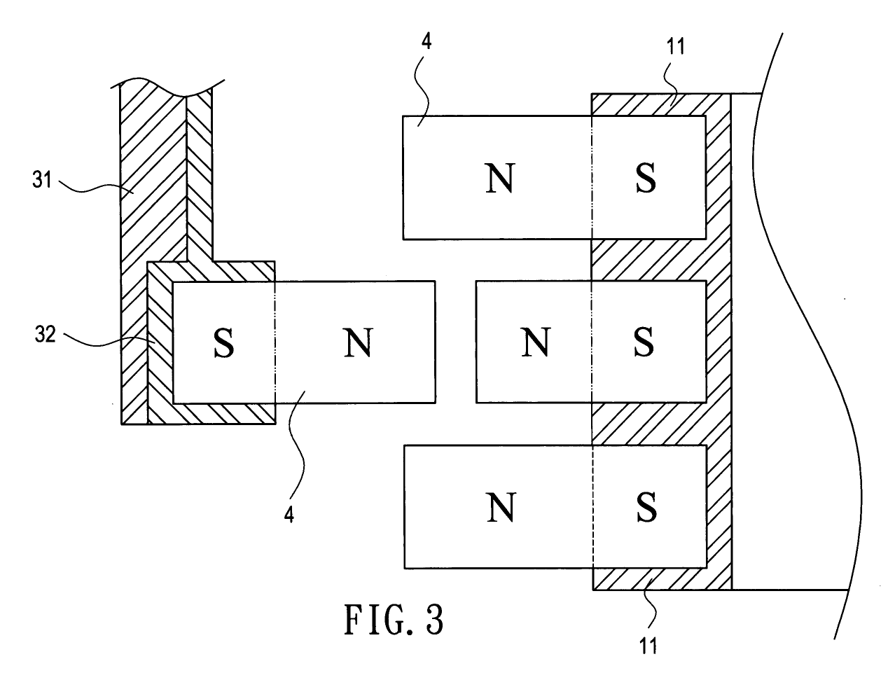

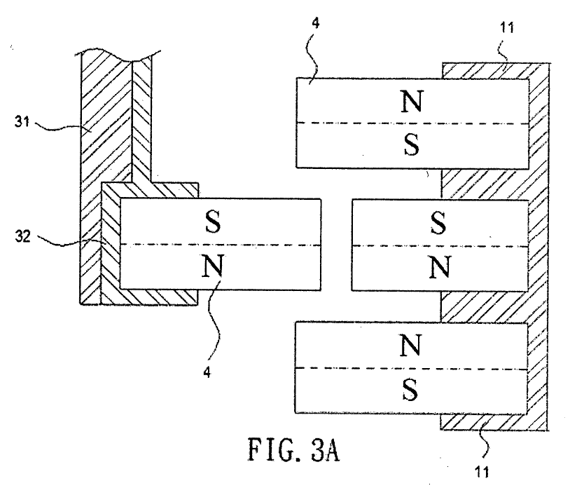

Referring to FIG. 3, in the shaftless magnetic trajectory fan provide by the present invention, the poles at the inner edge of the ring-shaped magnets 4 of the two U-shaped magnetic conducting rings 11 are fully covered. In addition, the poles at the inner edge of the ring-shaped magnet 4 at the connection portion of the two U-shaped magnetic conducting rings 11 are fully covered by the two U-shaped magnetic conducting rings 11. The poles at the outer edge of the ring-shaped magnet 4 of the magnetic-levitated main body 32 are also fully covered. The poles of the ring-shaped magnets 4 of the two U-shaped magnetic conducting rings 11, the pole of the ring-shaped magnet 4 at the connection portion of the two U-shaped magnetic conducting rings 11 and the pole of the ring-shaped magnet 4 of the magnetic-levitated main body 32, which are covered, are identical to each other. For example, the poles of the ring-shaped magnets 4 of the two U-shaped magnetic conducting rings 11, the pole of the ring-shaped magnet 4 at the connection portion of the two U-shaped magnetic conducting rings 11 and the pole of the ring-shaped magnet 4 of the magnetic-levitated main body 32, which are covered, are all S-poles. Therefore, the magnetic-levitated main body 32 supports the magnetic fan 3 to suspend in the outer edge of the magnetic track 1 when the exposed pole of the ring-shaped magnet 4 provided in the magnetic-levitated main body 32 and the exposed like pole of the ring-shaped magnet 4 between the two ring-shaped magnets of the magnetic track 1 repel each other. Furthermore, since each of the two U-shaped magnetic conducting rings 11 and the magnetic-levitated main body 32 is made of a magnetic conducting material, the magnetic properties of the covered poles of the ring-shaped magnets 4 provided on the two U-shaped magnetic conducting rings 11, on the connection portion between the two U-shaped magnetic conducting rings 11 and in the magnetic-levitated main body 32 are conducted away by means of the magnetic conducting material so as to prevent the covered poles of the two U-shaped magnetic conducting rings 11 from attracting the exposed opposite pole of the magnetic-levitated main body 32 or the exposed poles of the two U-shaped magnetic conducting rings 11 from attracting the covered opposite pole of the magnetic-levitated main body 32.

Please refer to 3A. The upper pole and the lower pole of the ring-shaped magnet 4 covered by each of the two U-shaped magnetic conducting rings 11 may be different. For example, the poles at the upper edge and the bottom edge may be N-pole and S-pole, respectively. Whereas, the poles of the ring-shaped magnet 4 at the connection portion of the two U-shaped magnetic conducting rings 11 and the poles of the ring-shaped magnet 4 of the magnetic-levitated main body 32, which are covered, are opposite to the poles of the adjacent ring-shaped magnets 4 covered by the two U-shaped magnetic conducting rings 11. For example, for the ring-shaped magnet 4 at the connection portion of the two U-shaped magnetic conducting rings 11 and the ring-shaped magnet 4 of the magnetic-levitated main body 32, the poles at the upper edge and the bottom edge may be S-pole and N-pole, respectively.

The shaftless magnetic trajectory fan provided by the present invention, when comparing with other previous conventional technologies, has following advantages:

1. Since the shaftless magnetic trajectory fan provided by the present invention has no central shaft, the problem of generating noise occurred in the prior art is avoided.

2. Since the shaftless magnetic trajectory fan provided by the present invention is operated by magnetic levitation and no central shaft is provided, the conventional problems that a central shaft abrasion resulted from friction with the bearing or oil seal upon rotation and thus the fan rocks itself when re-started are avoided, thereby achieving the purpose of increasing the fan's service life.

3. Since the shaftless magnetic trajectory fan provided by the present invention is operated by magnetic levitation and no central shaft is provided, the problems that the dynamic energy loss due to the heat generated from friction of the central shaft with the bearing, the oil seal, the retaining hole or the base are avoided.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A shaftless magnetic trajectory fan operated according to the principle “like magnetic poles repel each other”, said shaftless magnetic trajectory fan comprising:
a magnetic track comprising two outwardly-opened U-shaped magnetic conducting rings coupled with each other, wherein each of said two U-shaped magnetic conducting rings has therein a ring-shaped magnet with different poles at the inner and outer edges, and the connection portion of said two U-shaped magnetic conducting rings has thereon another ring-shaped magnet with different poles at the inner and outer edges;
a controller having thereon several electromagnets formed of coils; and
a magnetic fan comprising a top cover with several blades on the outer edge and a magnetic-levitated main body, wherein said magnetic-levitated main body has therein a ring-shaped magnet with different poles at the inner and outer edges, the pole at the inner edge of said ring-shaped magnet of said magnetic-levitated main body is the same as that at the outer edge of said ring-shaped magnet of said magnetic track, said magnetic-levitated main body is upwardly coupled with a ring-shaped magnet corresponding to said electromagnets of said controller, and said top cover covers the outer edge of said magnetic-levitated main body;
wherein said ring-shaped magnet provided in said magnetic-levitated main body of said magnetic fan is accommodated between said two ring-shaped magnets of said magnetic track such that said ring-shaped magnet provided in said magnetic-levitated main body faces to said ring-shaped magnet at the connection portion of said two U-shaped magnetic conducting rings, said ring-shaped magnet provided in said magnetic-levitated main body is suspended between said two ring-shaped magnets of said magnetic track according to the principle “like magnetic poles repel each other” and suspended in the outer edge of said magnetic track when interacted by said ring-shaped magnet at the connection portion of said two U-shaped magnetic conducting rings, and said ring-shaped magnet with which said magnetic-levitated main body is upwardly coupled drives rotation of said magnetic fan when a circuit flows through said electromagnets of said controller.

2. The shaftless magnetic trajectory fan according to claim 1, wherein the inner edge of said ring-shaped magnet provided in said magnetic-levitated main body has several openings for placing therevia said ring-shaped magnet of said magnetic-levitated main body between said two ring-shaped magnets of said magnetic track.

3. The shaftless magnetic trajectory fan according to claim 1, wherein each of said two U-shaped magnetic conducting rings and said magnetic-levitated main body is made of a magnetic conducting material.

4. The shaftless magnetic trajectory fan according to claim 1, wherein the poles at the inner edge of said ring-shaped magnets of said two U-shaped magnetic conducting rings are fully covered.

5. The shaftless magnetic trajectory fan according to claim 1, wherein the poles at the inner edge of said ring-shaped magnet at the connection portion of said two U-shaped magnetic conducting rings are fully covered by said two U-shaped magnetic conducting rings.

6. The shaftless magnetic trajectory fan according to claim 1, wherein the poles at the outer edge of said ring-shaped magnet of said magnetic-levitated main body are fully covered.

7. The shaftless magnetic trajectory fan according to claim 1, wherein the poles of said ring-shaped magnets of said two U-shaped magnetic conducting rings, the pole of said ring-shaped magnet at the connection portion of said two U-shaped magnetic conducting rings and the pole of said ring-shaped magnet of said magnetic-levitated main body, which are covered, are identical to each other.

8. The shaftless magnetic trajectory fan according to claim 1, wherein the poles at the upper edge and the bottom edge of said ring-shaped magnets for each of said two U-shaped magnetic conducting rings are different, and the poles of said ring-shaped magnet at the connection portion of said two U-shaped magnetic conducting rings and the poles of said ring-shaped magnet of said magnetic-levitated main body are opposite to the poles of the adjacent ring-shaped magnets covered by said two U-shaped magnetic conducting rings.
